(19) United States
(12) Patent Application Publication
(10) Pub. No.: US 2010/0224523 A1
(43) Pub. Date: Sep. 9, 2010

(54) SUPPORT BAR AND SUBSTRATE CASSETTE

(75) Inventors: Ichiro Yuasa, Tochigi (JP); Yuichi Maruyama, Tokyo (JP); Terukazu Toki, Tochigi (JP); Isao Fukazu, Tochigi (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT NEMOURS AND COMPANY, Wilmington, DE (US)

(21) Appl. No.: 12/279,849

(22) PCT Filed: Apr. 4, 2007
(86) PCT No.: PCT/US2007/008484

§ 371 Date: Aug. 19, 2008

(30) Foreign Application Priority Data
Apr. 7, 2006 (JP) 2006-106675

(51) Int. Cl. B65D 85/48; F16M 13/00

(52) U.S. Cl. 206/454; 248/346.01

(57) ABSTRACT

The present invention relates to a substrate cassette support bar in a substrate cassette for housing a plurality of horizontally oriented substrates in multiple levels in the vertical direction, the substrate bar being arranged so as to inhibit bending of the central portion of each substrate, comprising: an upper plate made of a carbon fiber composite material; a lower plate made of a carbon fiber composite material; and an intermediate member disposed between the upper plate and the lower plate, and made of a material other than a carbon fiber composite material.

### BACKGROUND OF THE INVENTION

1. Field of the Invention

The present invention relates to a support bar that is a constituent member of a substrate cassette used to store various types of substrates such as glass substrates and so forth used in liquid crystal displays. More particularly, the present invention relates to a support bar that is thin, able to inhibit bending caused by vibrations during use, and is lightweight. The present invention also relates to a substrate cassette that uses this support bar.

2. Description of the Related Art

In the production process of liquid crystal displays, substrate cassettes that house a plurality of horizontally oriented glass substrates in multiple levels in the vertical direction are used to temporarily store glass substrates. These substrate cassettes, when viewed from the front of the substrate cassette in the state of storing substrates, normally contain a plurality of support bars that support each substrate by being alternately positioned with a plurality of substrates in the vertical direction.

From the viewpoint of production efficiency of the liquid crystal displays, the functions required of a substrate cassette include being able to house and store a large number of glass substrates. Consequently, the support bars, which are the constituent members of the substrate cassette and directly support the glass substrates, are required to be as thin as possible in the vertical direction and allow vertically adjacent glass substrates to be stored in extremely close proximity.

In addition, from the viewpoint of guaranteeing the quality of the glass substrates, another function required of the substrate cassette is to prevent the stored glass substrates from contacting each other. Namely, although a substrate cassette normally houses several tens of glass substrates, the vertically adjacent glass substrates must not be allowed to contact each other resulting in damage to the surfaces thereof. Consequently, the support bars that directly support the glass substrates are required to be resistant to bending.

Moreover, from the viewpoint of workability during liquid crystal display production, another function required of the substrate cassette is to be lightweight overall. In particular, since the glass substrates used in the production of liquid crystal displays have become increasingly large in recent years, the substrate cassettes used for the storage thereof are also becoming correspondingly larger. Therefore, the support bars serving as constituent members of these substrate cassettes are required to be as lightweight as possible.

In this manner, support bars are required to have the apparently offsetting characteristics of thinness and resistance to bending, while also being required to be as lightweight as possible.

Examples of support bars, storage cassettes containing support bars and related technology thereto have been disclosed as indicated below.

Japanese Patent Application Laid-open No. 2000-7148 discloses a glass substrate cassette that houses or stores, for example, glass substrates used in liquid crystal display devices. This reference defines a glass substrate cassette that houses glass substrates that is provided with edge supports composed so as to support the edges of housed glass substrates, and a central support section composed so as to support the central portions of the glass substrates.

Japanese Patent Application Laid-open No. 2000-142876 discloses a substrate-housing cassette used to house, for example, plastic substrates used in the production process of liquid crystal display elements using plastic substrates. This reference defines a substrate housing cassette comprising a front panel having an opening for removing and inserting substrates, and upper, lower, right side, left side and back panels provided with holes, and provided with substrate edge supports protruding from both side panels towards the inside for supporting the left and right edges of the substrates, and a substrate central support protruding from the back panel towards the inside for supporting the central portion of the substrates.

Japanese Patent Application Laid-open No. 2004-146578 discloses a cassette substrate support member and a substrate cassette that enables the weight of the substrate cassette to be reduced. This reference defines a cassette substrate support member used in substrate cassettes that house substrates in a layered state for supporting the substrates from below at predetermined intervals that is provided so as to protrude to the inside from the substrate cassette frame, and has ribs made of long rod-like members, holding members provided on one end of the ribs for fixing the ribs to the frame, and auxiliary support members provided on the ribs at predetermined intervals along the axial direction of the ribs; wherein, the ribs have a carbon fiber-reinforced plastic material that contains carbon fibers oriented in the axial direction thereof.

US Patent Application Publication No. 2006/0011507 discloses a substrate housing cassette used in the production process of various types of substrates such as glass substrates used in liquid crystal display devices, and more particularly, a central support member (support bar) disposed at each level of the cassette. This reference defines a substrate cassette support bar for supporting each substrate so as to inhibit bending of the central portion thereof in a substrate cassette that houses a plurality of horizontally oriented substrates in multiple levels in the vertical direction; wherein, said support bar is formed with a carbon fiber composite material that contains highly elastic carbon fibers having a tensile elastic modulus of 490 to 950 GPa at 30% by volume or more.

As has been described above, although various support bars, substrates cassettes and related technologies thereto have been disclosed, in the case of applying these technologies to the storage of so-called 8th generation large-sized glass substrates, there is the possibility of bending of the support bar in particular becoming a problem. Consequently, there is a need for a support bar that can be adequately applied to the storage of large-sized glass substrates and a substrate cassette provided with said support bar.

### SUMMARY OF THE INVENTION

Thus, an object of the present invention is to provide a support bar that is thin, resistant to bending and lightweight, and in particular, is able to be adequately applied to the storage of so-called 8th generation large-sized glass substrates, and a substrate cassette provided with said support bar. In addition, an object of the present invention is to provide a means for easily producing a long support bar.

The present invention relates to a substrate cassette support bar in a substrate cassette for housing a plurality of horizontally oriented substrates in multiple levels in the vertical direction, said substrate bar being arranged so as to inhibit bending of the central portion of each substrate, comprising: an upper plate made of a carbon fiber composite material; a lower plate made of a carbon fiber composite material; and an intermediate member disposed between the upper plate and the lower plate, and made of a material other than a carbon fiber composite material. In the support bar of the present invention, the intermediate member is preferably made of aluminum, stainless steel or honeycomb-shaped aramid fibers. In addition, the support bar of the present invention is preferably hollow.

In addition, the present invention relates to a substrate cassette provided with the above-mentioned support bar. The substrate cassette of the present invention is preferably provided with a frame formed on the back of the opposite side from the substrate insertion side, and an adjustment mechanism which is provided between the frame and the support bar and which adjusts distortion in at least one of the horizontal direction and the vertical direction of the support bar. In addition, in the substrate cassette of the present invention, the adjustment mechanism is preferably a mechanism that adjusts the angle of the support bar relative to the frame with a screw.

The support bar of the present invention is constituted by an upper plate, a lower plate, and an intermediate member arranged between these plates. This type of support bar can be manufactured more easily than support bars composed only of a carbon fiber composite material. More specifically, a cylindrical support bar made of a carbon fiber composite material as described in Japanese Patent Application Laid-open No. 2005-340480 has the characteristics of being lightweight and resistant to bending. However, the process by which this support bar is manufactured is complex and complicated. The manufacturing of this support bar is particularly difficult in the case of producing long support bars for use with 8th generation substrates and so forth. With respect to this point, the support bar of the present invention can be manufactured by simply layering plate-shaped carbon fiber composite materials and intermediate members, making the manufacturing process remarkably simple. Depending on the particular case, the upper plate, lower plate and intermediate member can be transported to a liquid crystal panel production factory and then assembled within the factory to enable the support bar to be manufactured even more easily.

In addition, the support bar of the present invention is a composite material composed of a carbon fiber composite material and an intermediate member made of another material. Consequently, vibration attenuation characteristics can be enhanced as compared with support bars made of carbon fiber composite materials alone. Accordingly, contact between glass substrates during bending of the support bar can be effectively prevented. This characteristic is extremely useful in long support bars used for 8th generation substrates in particular.

Moreover, in the support bar of the present invention, the upper plate and the lower plate are made of carbon fiber composite materials. Consequently, a support bar can be provided that is both lightweight and thin.

In addition, the substrate cassette of the present invention can be preferably used to store glass substrates in a liquid crystal display production process due to each of the effects of the support bar resulting from its thinness, inhibition of bending and light weight. Since the bending inhibitory effects in particular of the substrate cassette of the present invention are extremely high, it is preferable for the storage of large-sized glass substrates such as so-called 8th generation substrates. However, the present invention is not limited to 8th generation substrates, but rather can naturally also be applied to other sizes of glass substrates as well.

### BRIEF DESCRIPTION OF THE DRAWINGS

FIG. 1A is a perspective view, FIG. 1B an overhead view and FIG. 1C a side view of a support bar 12 as an example of the present invention;

FIG. 2A is an overhead view and FIG. 2B is a front view of an example of a support bar of the present invention in which the intermediate member is a hollow quadratic prism;

FIG. 3A is an overhead view, FIG. 3B is a side view and FIG. 3C is a back view of an example of a support bar of the present invention in which the intermediate member is a U-shaped member;

FIG. 4A is an overhead view, FIG. 4B is a side view and FIG. 4C is a front view of an example of a support bar of the present invention in which the intermediate member is made of honeycomb-shaped aramid fibers;

FIG. 5 is a schematic perspective view of an example of a glass substrate cassette 32 provided with support bars of the present invention;

FIG. 6 is a perspective view of an example of a structure for fixing support member 38 and support bars 40 in the present invention; and,

FIG. 7A is an overhead view and FIG. 7B is a longitudinal cross-sectional view of an example of a structure for fixing support member 38 and support bars 40.

### DESCRIPTION OF THE PREFERRED EMBODIMENTS

The following provides a detailed explanation of the support bar and substrate cassette of the present invention with reference to the drawings.

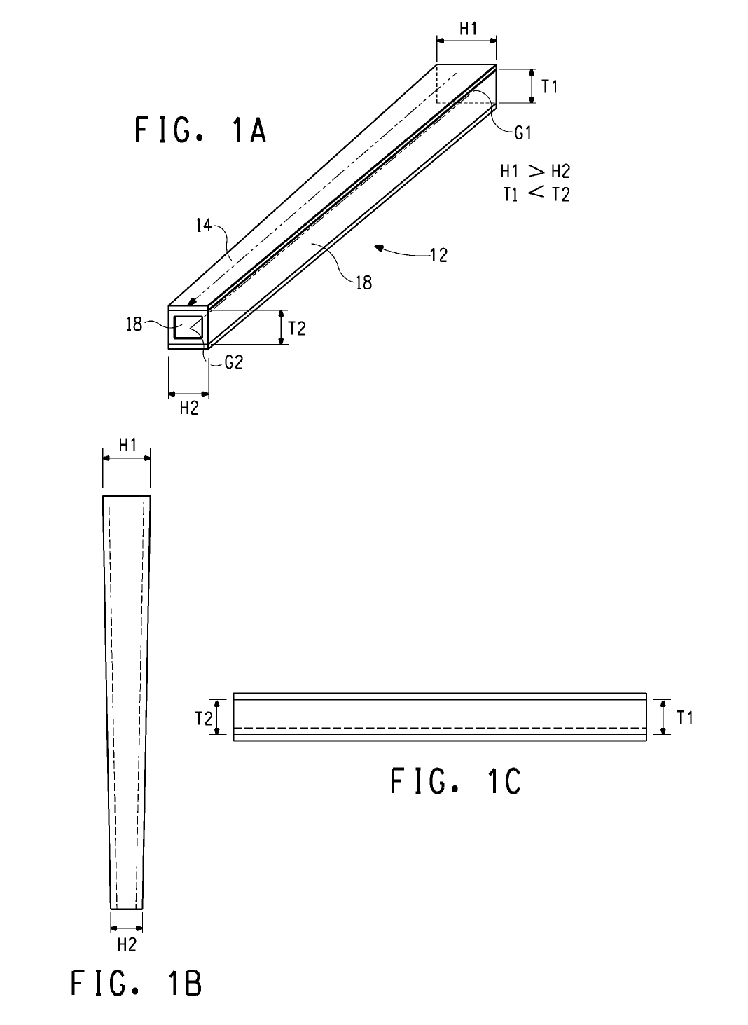

FIG. 1A is a perspective view, FIG. 1B is an overhead view and FIG. 1C is a side view of a support bar 12 as an example of the present invention. In this example, support bar 12 is constituted by an upper plate 14 made of a carbon fiber composite material (carbon fiber-reinforced plastic, abbreviated simply as “CFRP”), a lower plate 16 made of CFRP, and a hollow intermediate member 18 arranged between upper plate 14 and lower plate 16 and made of a material other than CFRP, and has a hollow structure overall. Furthermore, although the example shown in FIG. 1 is an example of a hollow structure, the support bar of the present application is not limited to this form, but rather can also employ a solid structure.

There are no particular limitations on the composition of the CFRP used for the material of upper plate 14 and lower plate 16. A wide range of known materials can be applied for the CFRP. Lightweight CFRP that is also resistant to bending is used preferably. An example of a CFRP that is used is that which contains 30% by volume or more of highly elastic carbon fibers having a tensile elastic modulus of 490 to 950 GPa. If the content is 30% by volume or more, members are obtained that have adequate rigidity and high vibration attenuation characteristics. The content of the highly elastic carbon fibers is preferably 40% by volume or more. In addition, although all of the reinforcing fibers used may be highly elastic carbon fibers, a portion of the members may also be made of other reinforcing fibers such as carbon fibers having a tensile elastic modulus of less than 490 GPa, glass fibers, aramid fibers, silicon carbide fibers or other known reinforcing fibers. For example, a combination can be used in which the content of highly elastic carbon fibers is no more than 90% by volume, while the remainder consists of other reinforcing fibers, and particularly carbon fibers having a tensile elastic modulus of less than 490 GPa.

In addition, in the example shown in FIG. 1, a material other than a carbon composite material is used for intermediate member 18 arranged between upper plate 14 and lower plate 16. For example, intermediate member 18 is preferably formed from aluminum or stainless steel having high strength and corrosion resistance.

The following provides an explanation of various aspects of the support bar of the present invention, and particularly aspects in which the intermediate member has been suitably altered.

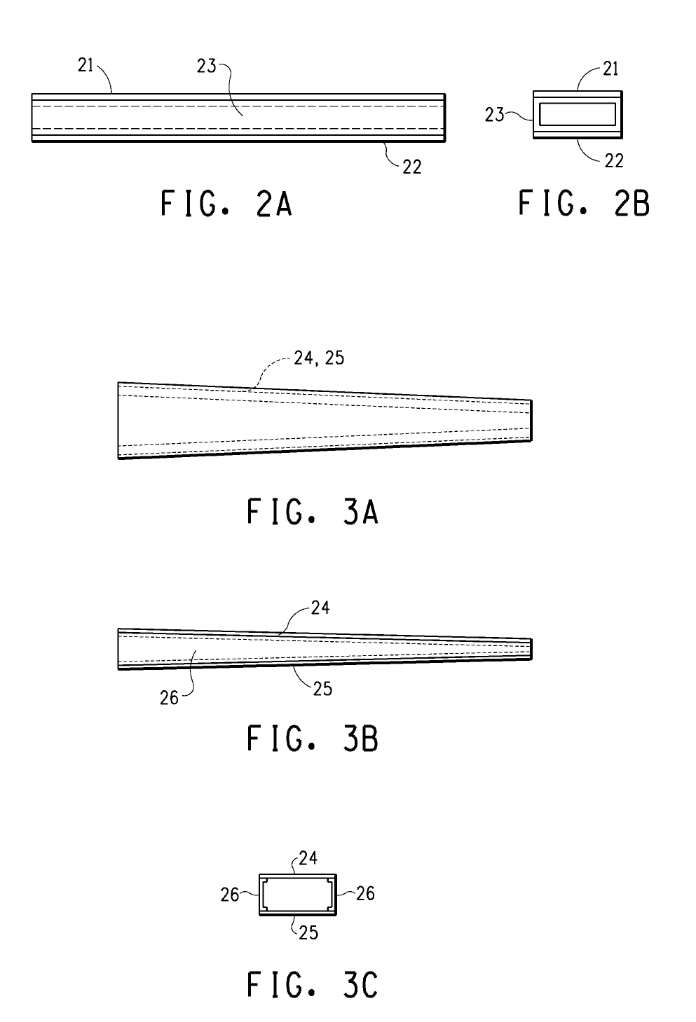

FIG. 2A is a side view and FIG. 2B is a front view (as viewed from the side of FIG. 2A) of one aspect of a support bar of the present invention. In this example, the support bar is constituted by an upper plate 21, a lower plate 22 and a hollow quadratic prism intermediate member 23 arranged between these plates 21 and 22. The use of an intermediate member of this form makes it possible for the entire support bar to demonstrate lightweight, adequate strength and bending rigidity.

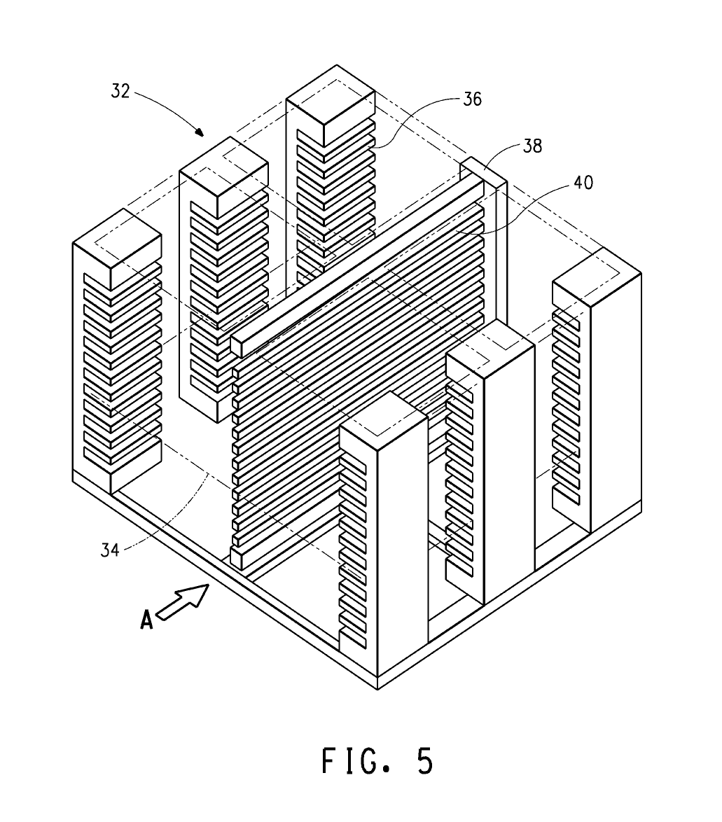

FIG. 3A is an overhead view, FIG. 3B is a side view and FIG. 3C is a back view (as viewed from the left side of FIG. 3B) of one aspect of a support bar of the present invention. In this example, the support bar is constituted by an upper plate 24, a lower plate 25 and a U-shaped intermediate member 26 arranged between these plates 24 and 25. The use of an intermediate member of this form makes it possible to reduce the weight of the support bar in comparison with the example shown in FIG. 2 since the shape of the intermediate member can be made to be smaller. In addition, in the case of support bars extending in a single direction as in the substrate cassette shown in FIG. 5 to be described later, the effect of reducing bending of the end of the support bar is large.

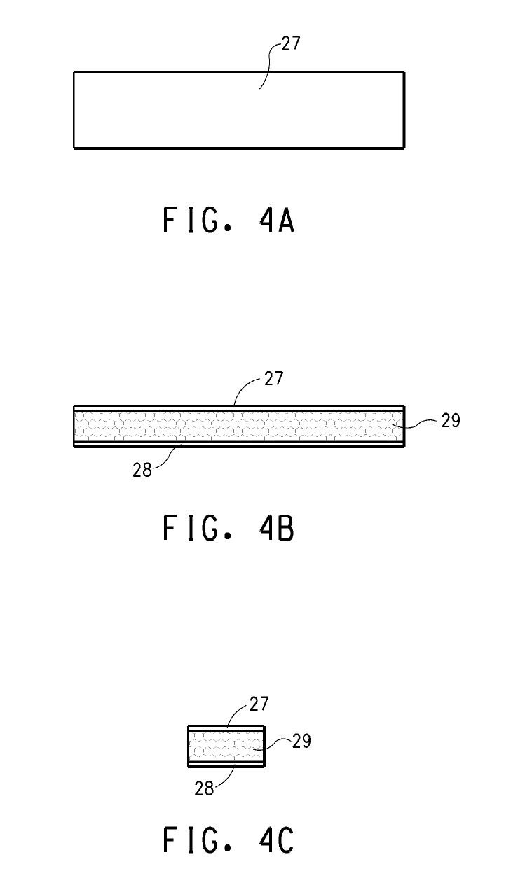

FIG. 4A is an overhead view, FIG. 4B is a side view and FIG. 4C is a front view (as viewed from the side of FIG. 4B) of one aspect of a support bar of the present invention. In this example, the support bar is constituted by an upper plate 27, a lower plate 28 and an intermediate member 29 made of honeycomb-shaped aramid fibers arranged between these plates 27 and 28. The use of this type of intermediate member makes it possible to reduce the weight of the support bar at an extremely high level. Since aramid fibers have roughly five times the strength of ordinary steel wire, are lightweight, and have superior heat resistance, impact resistance and so on, they are particularly advantageous for use as intermediate member 29.

As shown in FIG. 1, in the case of adopting a hollow structure for the entirety of support bar 12, it is preferable that the fixed end of the support bar have a structure in which the outer circumference of the cross-section that is perpendicular to the lengthwise direction of the support bar becomes smaller moving towards the free end in order to obtain higher vibration attenuation characteristics. Here, the “lengthwise direction” refers to the direction of a line that connects the cross-sectional center of gravity (G1) of the fixed end and the cross-sectional center of gravity (G2) of the hollow support bar 12 shown in FIG. 1.

In support bar 12 shown in FIG. 1, in the case of defining the width and height of the fixed end as H1 and T1, respectively, and the width and height of the free end as H2 and T2, respectively, support bar 12 has a tapered shape in which only the width becomes narrower moving towards the free end (H1>H2, T1=T2). However, the support bar of the present invention is not limited to this shape. In addition to support bar 12 having the shape shown in FIG. 1, a support bar of the present invention can also adopt a tapered shape in which, for example, only the thickness becomes smaller moving towards the free end (H1=H2, T1>T2). Moreover, although not shown in the drawings, a support bar of the present invention can also have a tapered shape in which both the width and height become smaller moving towards the free end (H1>H2, T1>T2 in FIG. 1).

In this manner, in the case the outer circumference of support bar 12 becomes smaller moving towards the free end, in order to reduce the amplitude during initial vibration, the outer circumference of the free end of support bar 12 is preferably ⅓ or more, and preferably ½ or more, the outer circumference of the fixed end. On the other hand, in order to demonstrate effects with respect to vibration attenuation characteristics by reducing the outer circumference even a little as compared with a support bar having the same outer circumference for the fixed and free ends, the outer circumference of the free end is preferably 9/10 or less, and more preferably ⅗ or less, the outer circumference of the fixed end.

In addition, an aspect in which the outer circumference becomes smaller moving in the direction of the free end is not limited to an aspect in which the outer circumference decreases uniformly from the fixed end towards the free end as shown in FIG. 1. For example, an aspect may be employed in which the outer circumference does not change at a portion near the fixed end and then gradually becomes smaller beyond that portion moving towards the free end, or an aspect may be employed in which the outer circumference decreases up to an intermediate portion in the lengthwise direction, and then remains constant after that section moving towards the free end, and various aspects can be employed.

Furthermore, although not shown in the drawings, the support bar of the present invention may be of a shape in which both the widths and heights of the fixed end and the free end are of the same dimensions (for example, H1=H2, T1=T2 in FIG. 1).

The free of end of support bar 12 may remain open as shown in FIG. 1, or a cap made of rubber or other elastic member may be inserted into the end of the opening.

Moreover, the length of the support bar 12 shown in FIG. 1 should be such that the support bar is able to support a substrate so that bending of the central portion is inhibited when the substrate is housed in a substrate cassette to be described later. Consequently, this length may be suitably determined according to the size of the substrate to be housed. In the present invention, the effects demonstrated by the present invention become increasingly prominent the greater the length of support bar 12. In particular, the present invention is extremely useful in the case in which the length of the support bar is 500 mm or more, preferably 1000 mm or more, and more preferably 2300 mm or more. There are no particular limitations on the width of support bar 12, and the minimum width is to be secured that allows the required strength and bending rigidity to be maintained for inhibiting bending of the central portion of the housed substrate corresponding to the manner in which the materials used are combined. In addition, the height can also be suitably set so that the minimum required strength and bending rigidity are able to be secured based on the relationship with width within the range of the pitch at which the substrates are housed.

A support bar 12 having a constitution as described above is constituted by an upper plate 14, a lower plate 16 and an intermediate member 18 arranged between these plates as shown, for example, in FIG. 1. As a result of adopting this type of constitution, the support bar can be manufactured easily. In addition, the upper plate 14 and the lower plate 16 of this support bar 12 are made of a carbon fiber composite material having a high degree of vibration dampening, and since a material different from the carbon fiber composite material is arranged for the intermediate member, bending inhibitory effects can be enhanced. Consequently, contact between glass substrates during bending of the support bar can be effectively prevented. Moreover, among each of the above-mentioned constituent members of the support bar of the present invention, since the upper plate and lower plate are formed from a carbon fiber composite material, they are ensured to have light weight. A support bar that is lighter in weight and demonstrates little bending (displacement) can be provided in the case of using a hollow shape for the intermediate member.

The following provides an explanation of a production method of the support bar of the present invention by focusing particularly on an example of a method for producing a tapered, hollow support bar as shown in FIG. 1. The fact that support bars having other shapes can also be produced by suitably altering the method described below can be easily understood by a person with ordinary skill in the art.

First, as a preliminary step, carbon fiber composite materials are prepared for the upper and lower plates, and an aluminum sheet is prepared for the intermediate member.

(Formation of Upper and Lower Plates)

The carbon fiber composite material used for the upper and lower plates is formed in the manner described below. First, a matrix resin is impregnated into a carbon fiber sheet to form an uncured prepreg sheet. This prepreg sheet, for example, preferably uses highly elastic carbon fibers having a tensile elastic modulus of 490 to 950 GPa at 30% by volume or more. In addition, glass fibers or other fibers can also be added to the carbon fiber composite material provided they do not impair the support performance of the upper and lower plates.

Thermosetting resins such as epoxy resin, phenolic resin, cyanate resin, unsaturated polyester resin, polyimide resin, bismaleimide resin and so on can be used for the matrix resin. In this case, that which is able to withstand high temperature and high humidity environments such as rubber vulcanization is preferable. In addition, a thermosetting resin in which fine particles made of rubber or resin have been added to a thermosetting resin for the purpose of imparting impact resistance and toughness, or a thermosetting resin in which a thermoplastic resin has been dissolved in a thermosetting resin may also be used for the thermosetting resin.

Although types of carbon fibers include PAN-based carbon fibers having a tensile elastic modulus of less than 490 GPa and pitch-based carbon fibers having a tensile elastic modulus of 490 to 950 GPa, these can be used in combination in the present invention. In this case, the pitch-based fibers have the characteristic of a high elastic modulus, while the PAN-based fibers have the characteristic of high tensile strength. In addition, examples of prepreg sheets include unidirectional sheets in which the reinforcing fibers are oriented in the same direction, and cross-woven sheets such as flat weaves, twill weaves, satin weaves and triaxial weaves. Unidirectional sheets are particularly preferable for highly elastic carbon fiber prepreg sheets having a tensile elastic modulus of 490 to 950 GPa.

Various types of prepreg sheets can be prepared, such as those having different types of reinforcing fibers, those having different usage ratios of reinforcing fibers to the matrix resin, or those having different orientations of reinforcing fibers. Consequently, the prepreg sheet to be used is preferably suitably selected according to the glass substrates to be held so that support bars having the optimum bending rigidity are formed.

The outer surface of the prepreg sheet may be covering with a cross-woven prepreg sheet as necessary. A cross-woven prepreg sheet refers to an uncured sheet in which the above-mentioned matrix resin is impregnated into reinforcing fibers woven in a plurality of directions. Woven carbon fibers, glass fibers, aramid fibers or silicon carbide fibers and so on are preferably used for the reinforcing fibers. In addition, a flexible, highly adhesive sheet is preferable so as to be able to closely adhere to and coat the prepreg sheet. Coating can be carried out closely adhering to the prepreg sheet while applying heat with an iron and so on.

As a result of coating with this cross-woven prepreg sheet, fluffing, unraveling and so on occurring at processed portions during post-processing such as cutting and boring following heat treatment can be prevented. Thus, the use of a cross-woven prepreg sheet offers the advantages of not only improving processability, but also reducing the generation of debris and so on without risk of damaging liquid crystal display substrates, plasma display substrates, silicon wafers or other precision substrates.

Next, the prepreg sheet is formed into a prepreg sheet section of predetermined dimensions. The shape of this prepreg sheet section is, for example, the shape of upper plate 14 and lower plate 16 shown in FIG. 1. The method used to form the prepreg sheet section can be cutting by mechanical processing or processing by a laser and so on.

The uncured prepreg sheet section obtained in this manner is placed in a vacuum bag and so on and then heated in an oven or similar apparatus while applying pressure to obtain the upper and lower plates. Heating conditions in this case consist of heating from room temperature at the rate of 2 to 10° C. per minute, holding at a temperature of about 100 to 190° C. for about 10 to 180 minutes, and then discontinuing heating and returning to room temperature by natural cooling. Here, the purpose of placing the uncured prepreg section in a vacuum bag is to apply external pressure (namely, atmospheric pressure) to the uncured members roughly uniformly.

(Formation of Intermediate Member)

The material used for the intermediate member is preferably a metal material having superior corrosion resistance such as aluminum or stainless steel. However, aluminum is used preferably in the case of realizing a high level of weight reduction for the support bar in particular. In addition, honeycomb-shaped aramid fibers are used more preferably in place of aluminum when desiring to further reduce the weight of the support bar.

These metal materials or aramid fibers are formed into a metal member and so on of predetermined dimensions according to known forming methods to obtain the intermediate member. For example, the intermediate member may have the shape of intermediate member 18 shown in FIG. 1. Forming can be carried out by cutting by machining or by processing with a laser and so forth.

(Formation of Support Bar)

The support bar is formed according to known forming methods using the upper plate, lower plate and intermediate member obtained in the manner described above. The support bar can be formed by, for example, by adhering these members. A two-liquid mixed type of epoxy adhesive, for example, can be used for the adhesive. Although there are no particular limitations on the adhesion conditions, an adhesive that can be cured at room temperature is used preferably in consideration of workability.

A support bar obtained in this manner can be manufactured easily as previously explained. In addition, since the support bar is in the form of a composite member with the upper plate, lower plate and other members, the entire support bar has the effect of inhibiting bending. Consequently, bending generated by vibration of the support bar is inhibited, thereby making it possible to effectively prevent contact between glass substrates during bending of the support bar. Moreover, further weight reduction of the support bar can be realized by using the above-mentioned materials and a hollow structure for the upper and lower plates.

In addition, it is not necessary to form a support bar 12 like that shown in FIG. 1 by going through a complex production process, such as wrapping numerous layers of a non-vulcanized sheet at predetermined angle relative to a core, as in the case of forming cylindrical support bars. Consequently, the production efficiency of the support bar can be improved dramatically. As a result, support bars can be produced both easily and inexpensively.

Although the preceding paragraphs have provided an explanation of the support bar of the present invention, the following provides an explanation of a substrate cassette that uses these support bars.

FIG. 5 is a schematic perspective view of an example of a glass substrate cassette 32 provided with support bars of the present invention. Glass substrates or other substrates 34 are inserted and removed from the direction of arrow A shown in FIG. 5. Shelves 36, which serve as edge supports for supporting the edges of housed substrates, are provided in multiple levels on both sides of the substrate entrance, a row of support bars 40 are provided in the vertical direction that have fixed ends fixed with a support member 38 fulfilling the role of a frame on the opposing side from the substrate entrance, and substrates 34 are held horizontally while inhibiting bending of the central portions of substrates 34. In FIG. 5, although a constitution is shown in which a row of support bars 40 in the vertical direction are provided nearly in the center of the opposing side from the substrate entrance, the present invention is not limited thereto, but rather a plurality of rows may be used provided they are able to inhibit bending of the central portions of substrates 34.

Known members can be used for those members other than support bars 40 that compose substrate cassette 32. In addition, known methods can be used to assemble these members. Moreover, edge support shelves 36 as well as other constituent members, such as a bottom frame, top frame and back frame serving as the opposing side from the substrate entrance, can also be made of a carbon fiber composite material. In this case, both lightweight and rigidity of substrate cassette 32 can be simultaneously realized at a high level.

In the example shown in FIG. 5, although the width of each shelf 36 is made to be wider than the width of support bars 40, a plurality of shelves 36 having a width roughly equal to that of support bars 40 can be arranged at predetermined intervals on both sides of the substrate entrance. In addition, a plurality of shelf units (three in FIG. 5), which are separated in the lengthwise direction of support bars 40, can also be arranged at predetermined intervals as shown in FIG. 5.

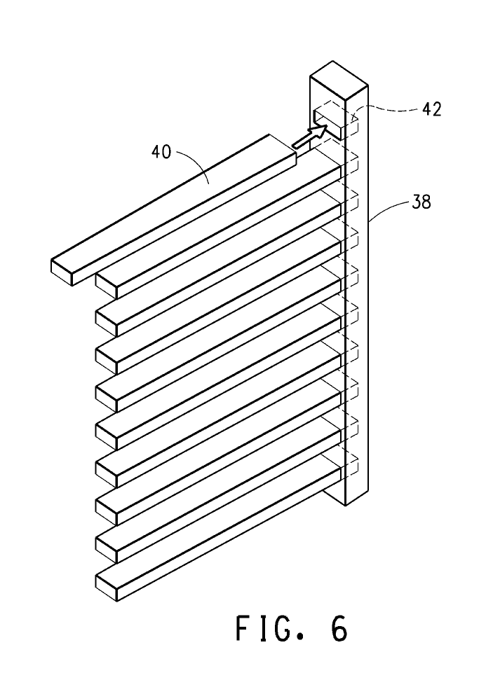

Although support bars 40 are fixed in a row in the vertical direction at a predetermined pitch on support member 38, there are no particular limitations on the manner in which they are fixed to support member 38. As shown in FIG. 6, for example, a known method may be employed such as providing at a predetermined pitch a plurality of grooves 42 enabling insertion of support bars 40 in support member 38, inserting support bars 40 therein, and then fixing in position by bolting or other means.

There are considerable differences in the vibration mode of fixed support bars 40 in this type of structure for fixing support bars 40 depending on the dimensions, shape, weight and soon of the substrates held thereby. Consequently, it is advantageous to mount an adjustment mechanism capable of suitably altering the fixing structure of support bars 40 between support member 38 and support bar 40 so as to minimize the vibration mode.

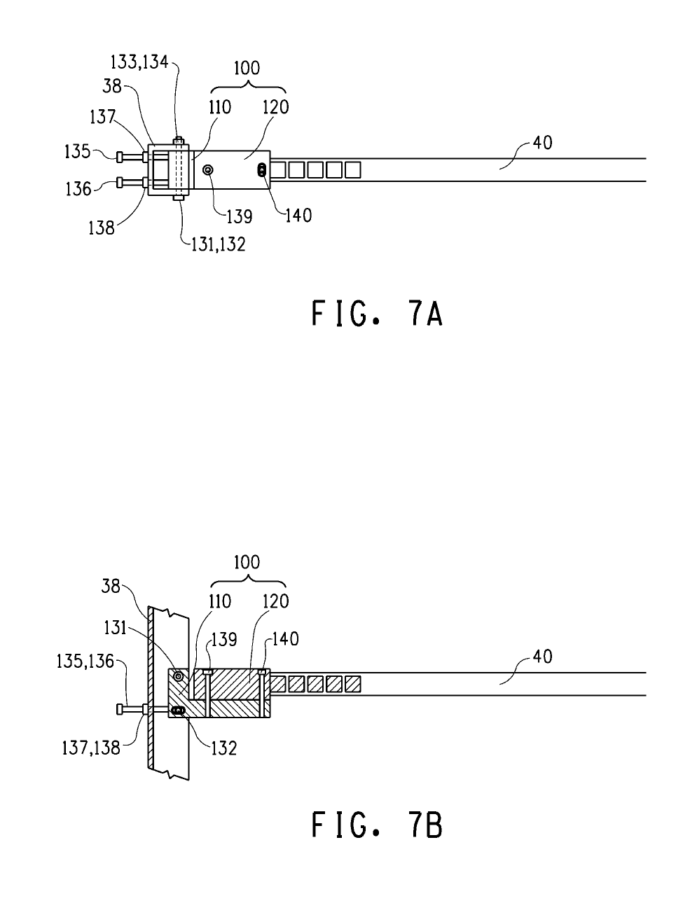

FIG. 7A is an overhead view and FIG. 7B is a longitudinal cross-sectional view of an example using an adjustment mechanism 100 in a fixing structure between a support member 38 of a substrate cassette frame and a support bar 40. In FIGS. 7A and 7B, a support bar 40 is fixed to a support member 38 through an adjustment mechanism 100. Adjustment mechanism 100 is constituted by a vertical direction adjustment mechanism 110 for adjusting support bar 40 relative to support member 38 in the vertical direction, and a horizontal direction adjustment mechanism 120 coupled with the vertical direction adjustment mechanism 110, for adjusting support bar 40 relative to support member 38 in the horizontal direction.

As shown in FIGS. 7A and 7B, the vertical direction adjustment mechanism 110 is fixed by two bolts 131 and 132 and corresponding lock nuts 133 and 134 to support member 38 in the state of being surrounded by support member 38 in three directions (FIG. 7A). Vertical direction adjustment mechanism 110 has a structure that allows rotation about the bolt hole of bolt 131 by directional displacement in FIG. 7B mediated by corresponding lock nuts 137 and 138 of bolts 135 and 136. Horizontal direction adjustment mechanism 120 is fixed to vertical direction adjustment mechanism 110 by bolts 139 and 140, and has a structure that allows rotation about the bolt hole of bolt 139. Support bar 40 is joined to horizontal direction adjustment mechanism 120 by a known method such as adhesion in the state in which the projecting portion of horizontal direction adjustment mechanism 120 is inserted therein.

Here, vertical direction adjustment mechanism 110 can be made of any material provided it can be firmly coupled with support member 38 and bolted to horizontal direction adjustment mechanism 120. For example, the use of aluminum is preferable in terms of light weight and processing ease. In addition, horizontal direction adjustment mechanism 120 can also be made of any material provided it can support a support bar 40 and be bolted to vertical direction adjustment mechanism 110. Similar to the horizontal direction adjustment mechanism, the use of aluminum is preferable in terms of light weight and processing ease.

In addition, formation of adjustment mechanism 100 can be carried out by separately forming each adjustment mechanism 110 and 120, in which bolt holes of predetermined diameters have been formed at predetermined locations, and then bolting these adjustment mechanisms 110 and 120 with bolts 139 and 140 corresponding to the mode of use of angle adjustment in the horizontal direction.

Next, an explanation is provided of a mode of use of this adjustment mechanism 100.

First, support bar 40 and horizontal direction mechanism 120 are firmly joined with the projecting portion of horizontal direction adjustment mechanism 120 inserted into a hollow support bar 40.

Next, horizontal direction adjustment mechanism 120 is rotated by predetermined angle relative to vertical direction adjustment mechanism 110 when coupling horizontal direction adjustment mechanism 120 and vertical direction adjustment mechanism 110, which as a result, determines the angle in the horizontal direction of support bar 40 relative to support member 38. Here, although the dimensions of the bolt hole of bolt 139 perfectly match the dimensions of bolt 139, the dimensions of the bolt hole of bolt 140 is slightly larger than the dimensions of bolt 140, thereby enabling support bar 40 to move in the horizontal direction. The bolt hole of bolt 140 can have, for example, a roughly elliptical shape having its major axis in the horizontal direction as shown in FIG. 7A (vertical direction in FIG. 7A). The shape of the bolt hole of bolt 140 may also be in the form of an arc-shaped slot. As a result of employing such a structure, in the case of rotating horizontal direction adjustment mechanism 120 relative to vertical direction adjustment mechanism 110 in the horizontal plane, horizontal direction adjustment mechanism 120 is rotated about the location of the bolt hole of bolt 139 in the state in which bolts 139 and 140 have been loosened. Next, the rotational position of horizontal direction adjustment mechanism 120 relative to vertical direction adjustment mechanism 110, namely the angle in the horizontal direction of support bar 40 relative to support member 38, can be determined by tightening bolts 139 and 140.

Moreover, vertical direction adjustment mechanism 110 is rotated by predetermined angle in the vertical plane relative to support member 38 when coupling vertical direction adjustment mechanism 110 and support member 38, which as a result, determines the angle in the vertical direction of support bar 40 relative to support member 38. Here, although the dimensions of the bolt hole of bolt 131 perfectly matches the dimensions of bolt 131, the dimensions of the bolt hole of bolt 132 are slightly larger than the dimensions of bolt 132, thereby enabling support bar 40 to move in the vertical direction. The bolt hole of bolt 132 can have, for example, a roughly elliptical shape having its major axis in the vertical direction as shown in FIG. 7B. The shape of the bolt hole of bolt 132 may also be in the form of an arc-shaped slot. As a result of employing this structure, in the case of rotating vertical direction adjustment mechanism 110 in the vertical plane relative to support member 38, vertical direction adjustment mechanism 110 is either pushed to the right or returned to the left in FIG. 7B and vertical direction adjustment mechanism 110 is rotated about the location of the bolt hole of bolt 131 by displacing bolts 135 and 136 in the horizontal direction in FIG. 7B in the state in which bolts 131 and 132 have been loosened. Next, the rotational position of vertical direction adjustment mechanism 110 relative to support member 38, namely the angle in the vertical direction of support bar 40 relative to support member 38, is determined by tightening bolts 131 and 132.

Vertical direction adjustment mechanism 110 and horizontal direction adjustment mechanism 120 can be finely adjusted after having produced the substrate cassette. For example, in the case the direction of a single support bar has shifted during the course of use of the substrate cassette, the direction of the support bar can be adjusted to a suitable direction simply by adjusting the adjustment mechanism.

Another example of a usage form of the adjustment mechanism is that which adjusts the angle corresponding to the weight of the glass substrates. In other words, bolt 132 is positioned towards the right side of the bolt hole thereof and tightened for support bars for which the weight of the glass substrates held is comparatively light, while conversely, bolt 132 is positioned towards the left side of the bolt hole and tightened incase the glass substrates are comparatively heavy to prevent contact between vertically adjacent glass substrates.

In addition, as a result of employing adjustment mechanism 100 having the structure and function described above, by tightening bolt 140 at the same position in the bolt hole thereof for, for example, all support bars 40 fixed to the substrate cassette, the direction in which support bars 40 extend within the substrate cassette can be made to be uniform, thereby giving the substrate cassette an overall superior appearance. In addition, since the ends of the support bars are aligned, it becomes easy to insert and remove substrates thereby making it possible to improve workability.

Furthermore, although the example shown in FIG. 7 has adjustment mechanism 100 constituted by vertical direction adjustment mechanism 110 and horizontal direction adjustment mechanism 120, one of these can be omitted so that adjustment mechanism 100 adjusts the angle of support bar 40 in a desired direction only. Furthermore, in any case, the leftmost portion of adjustment mechanism 100 in FIGS. 7A and 7B is required to have a mechanism for coupling support member 38, while the rightmost portion of adjustment mechanism 100 is required to have a mechanism for coupling support bars 40. The effects demonstrated by adjustment mechanism 100 are diminished unless support member 38 and adjustment mechanism 100, and adjustment mechanism 100 and support bars 40, are firmly coupled so that they do not shift out of position.

The support bar of the present invention is useful for storing glass substrates used in the production process of liquid crystal displays as a result of demonstrating each of the effects of thinness, inhibition of bending and light weight. Moreover, the support bar of the present invention can be manufactured easily. In addition, the substrate cassette of the present invention is particularly useful for storing large-sized glass substrates referred to as 8th generation substrates.

What is claimed is:

1. A support bar in a substrate cassette for housing a plurality of horizontally oriented substrates in multiple levels in the vertical direction, said substrate bar being arranged so as to inhibit bending of the central portion of each substrate, comprising:
an upper plate made of a carbon fiber composite material;
a lower plate made of a carbon fiber composite material; and
an intermediate member disposed between the upper plate and the lower plate, and made of a material other than a carbon fiber composite material.

2. The support bar according to claim 1, wherein the intermediate member is made of aluminum.

3. The support bar according to claim 1, wherein the intermediate member is made of stainless steel.

4. The support bar according to claim 1, wherein the intermediate member is made of honeycomb-shaped aramid fibers.

5. The support according to claims 1 that is hollow.

6. A substrate cassette, comprising the support bar according to claims 1.

7. The substrate cassette according to claim 6, further comprising a frame formed on the back of the opposite side from the substrate insertion side, and an adjustment mechanism which is provided between the frame and the support bar and which adjusts distortion in at least one of the horizontal direction and the vertical direction of the support bar.

8. The substrate cassette according to claim 7, wherein the adjustment mechanism is a mechanism that adjusts the angle of the support bar relative to the frame with a screw.
